(19) United States
(12) Patent Application Publication
(10) Pub. No.: US 2026/0238446 A1
(43) Pub. Date: Aug. 13, 2026

(54) OPPORTUNISTIC DMRS OR CSI-RS AIDED BEAM PREDICTION ACCURACY IMPROVEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/153,862

(22) PCT Filed: Apr. 6, 2023
(86) PCT No.: PCT/CN2023/086486

§ 371 Date: Aug. 5, 2025

(51) Int. Cl. H04L 5/00; H04W 72/21; H04W 72/51

(52) U.S. Cl. CPC H04L 5/0094; H04W 72/21; H04W 72/51

(57) ABSTRACT

Method and apparatus for an accuracy improvement for opportunistic DMRS or CSI-RS aided beam prediction. The apparatus receives a TCI state configuration regarding a target reference signal including at least one QCL configuration comprising spatial transmission parameters shared with a source signal. The apparatus receives, from a network entity, the target reference signal associated with the TCI state configuration, wherein a transmission spatial filter of the target reference signal corresponds to the source signal from the TCI state configuration. The apparatus may transmit, to the network entity, a report for the source signal of the TCI configuration and predicted channel characteristics. The apparatus may transmit, to the network entity, an indication of support for a UE capability associated with the at least one QCL configuration that comprises the spatial transmission parameters shared with the source signal.

### TECHNICAL FIELD

The present disclosure relates generally to communication systems, and more particularly, to a configuration for an accuracy improvement for opportunistic DMRS or CSI-RS aided beam prediction.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus receives a transmission configuration indicator (TCI) state configuration regarding a target reference signal including at least one quasi co-located (QCL) configuration comprising spatial transmission parameters shared with a source signal. The apparatus receives, from a network entity, the target reference signal associated with the TCI state configuration, wherein a transmission spatial filter of the target reference signal corresponds to the source signal from the TCI state configuration

In an aspect of the disclosure, a method, a computer-readable medium, and an apparatus are provided. The apparatus may be a device at a network node. The device may be a processor and/or a modem at a network node or the network node itself. The apparatus configures a TCI state configuration regarding a target reference signal including at least one QCL configuration comprising spatial transmission parameters shared with a source signal. The apparatus provides, to a user equipment (UE), the TCI state configuration regarding the target reference signal including the at least one QCL configuration comprising the spatial transmission parameters shared with the source signal. The apparatus provides, to the UE, the target reference signal associated with the TCI state configuration, wherein a transmission spatial filter of the target reference signal corresponds to the source signal from the TCI state configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of an artificial intelligence (AI)/machine learning (ML) algorithm.

FIG. 5 is a diagram illustrating an example of QCL Types.

FIG. 6 is a diagram illustrating another example of QCL Types.

FIG. 7 is a call flow diagram of signaling between a UE and a base station.

FIG. 8 is a flowchart of a method of wireless communication.

FIG. 9 is a flowchart of a method of wireless communication.

FIG. 10 is a diagram illustrating an example of a hardware implementation for an example apparatus and/or network entity.

FIG. 11 is a flowchart of a method of wireless communication.

FIG. 12 is a flowchart of a method of wireless communication.

FIG. 13 is a diagram illustrating an example of a hardware implementation for an example network entity.

### DETAILED DESCRIPTION

Beam prediction may have reduced accuracy, at times, due to insufficient measurements or observations. In some instances, DMRS and CSI-RS may be utilized to improve the prediction accuracy. For example, DMRS and/or CSI-RS may be transmitted to provide more opportunistic measurement resources to improve the accuracy of the beam prediction. Additionally, or alternatively, the added reference signals enable more opportunistic performance monitoring occasions for a UE to measure a DMRS and/or CSI-RS transmitted via the same beam as the UE predicted beam based on L1-RSRPs in an effort to verify the UE predicted L1-RSRPs. In another example, aperiodic CSI-RS (AP CSI-RS) transmitted via the same beam that has been used by the UE as AI/ML input for beam prediction may be used to refine or improve beam prediction accuracy or to verify the UE predicted L1-RSRPs.

QCL Type D may be associated with spatial reception parameters, and the network may determine the associated spatial transmission parameters. For example, a base station may utilize a beam for a transmission that is narrower than a QCL-source in order to improve throughput for the transmission. A UE may not assume that the same transmission beam is used for transmitting the transmission and the DMRS/CSI-RS QCL Type D source reference signal. The UE may derive the receive beam for receiving such DMRS/CSI-RS based on the reception beam that has been used to receive the corresponding QCL Type D source reference signal. As such, the UE may not assume that such DMRS/CSI-RS may be used as additional AI/ML inputs, nor used as prediction verification resource, for a transmission beam.

Various aspects relate generally to improving the accuracy of beam prediction. Some aspects more specifically relate to a QCL type that define spatial transmission parameters. In some examples, a UE may receive a TCI state configuration corresponding to a target reference signal that includes a QCL configuration comprising spatial transmission parameters that are shared with a source signal. The UE may receive the target reference signal with the TCI state configuration, such that a transmission spatial filter of the target reference signal corresponds to the source signal from the TCI state configuration.

Particular aspects of the subject matter described in this disclosure can be implemented to realize one or more of the following potential advantages. At least one advantage of the disclosure is that the QCL configuration comprising spatial transmission parameters may allow for an improvement of beam prediction accuracy based on spatial transmission parameters. The QCL configuration may comprise spatial transmission parameters that are shared with a source signal, which may allow for additional or opportunistic AI/ML input to refine or improve beam prediction, or may allow for opportunistic AI/ML performance monitoring.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

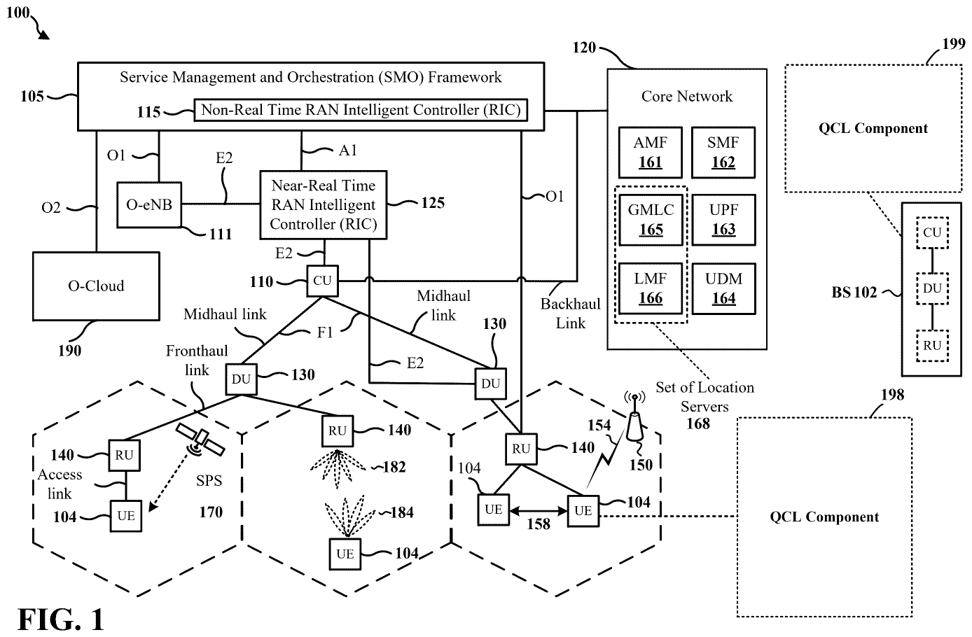

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a QCL component 198 configured to receive a TCI state configuration regarding a target reference signal including at least one QCL configuration comprising spatial transmission parameters shared with a source signal; and receive, from a network entity, the target reference signal associated with the TCI state configuration, wherein a transmission spatial filter of the target reference signal corresponds to the source signal from the TCI state configuration.

Referring again to FIG. 1, in certain aspects, the base station 102 may comprise a QCL component 199 configured to configure a TCI state configuration regarding a target reference signal including at least one QCL configuration comprising spatial transmission parameters shared with a source signal; provide, to a UE, the TCI state configuration regarding the target reference signal including the at least one QCL configuration comprising the spatial transmission parameters shared with the source signal; and provide, to the UE, the target reference signal associated with the TCI state configuration, wherein a transmission spatial filter of the target reference signal corresponds to the source signal from the TCI state configuration.

Although the following description may be focused on 5G NR, the concepts described herein may be applicable to other similar areas, such as LTE, LTE-A, CDMA, GSM, and other wireless technologies.

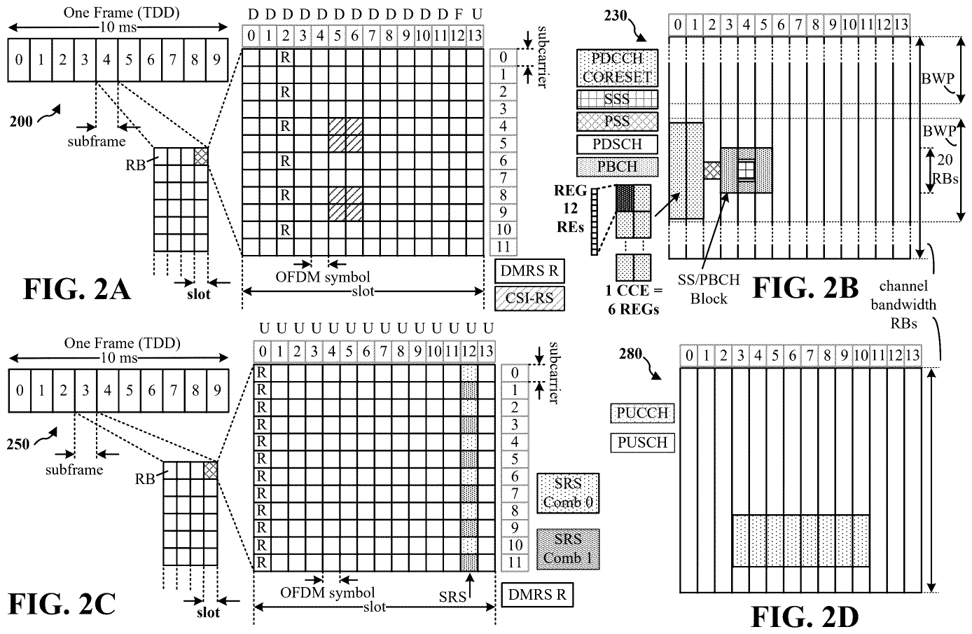

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

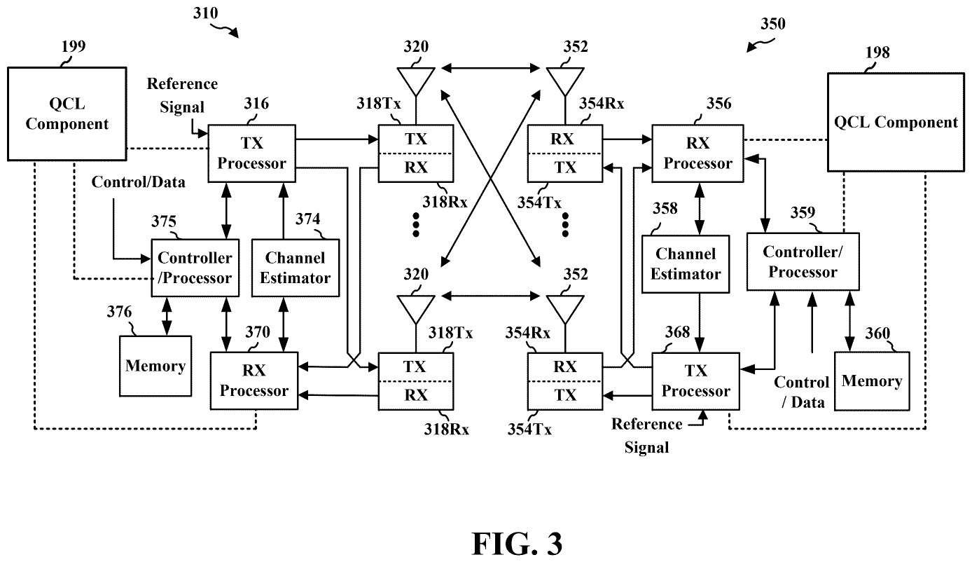

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the QCL component 198 of FIG. 1.

At least one of the TX processor 316, the RX processor 370, and the controller/processor 375 may be configured to perform aspects in connection with the QCL component 199 of FIG. 1.

The UE and the network may perform various aspects of beam management in order to select a beam for transmission and reception, e.g., as described in connection with 182 and 184 in FIG. 1. A base station and a UE may perform beam training to determine the best receive and transmit directions for each of the base station and the UE. The transmit and receive directions for the base station may or may not be the same. The transmit and receive directions for the UE may or may not be the same.

In response to different conditions, the beams used to transmit and receive communication between the UE and the base station may be switched. In some examples, the base station may send a transmission that triggers a beam switch by the UE. For example, the base station may indicate a TCI state change, and in response, the UE may switch to using a new beam for the new TCI state of the base station. Switching beams may allow for an improved exchange of communication between the UE and the base station by ensuring that the transmitter and receiver use the same configured set of beams for communication.

A TCI state may include quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals.

In some aspects, beam management may be performed using a tracking reference signal (TRS), e.g., for a UE in an RRC inactive or RRC idle state. For initial access, a UE may use an SSB, e.g., with a wide beam sweeping procedure to identify a beam to use for initial access. For contention based random access (CBRA), a UE may use a random access occasion (RO) and a preamble that corresponds to the selected SSB/beam. In an RRC connected state, the UE and/or network may perform various aspects of beam management, e.g., including a P1, P2, and P3 procedure using SSB or CSI-RS measurements; a U1, U2, and U3 procedure using SRS transmissions and measurement, L1-RSRP reporting. P1 may be referred to as a beam selection, P2 may be referred to as a beam refinement for the transmitter (e.g., base station), and P3 may be referred to as a beam refinement for a receiver (e.g., a UE). For P1, the base station may sweep transmissions over a set of beams. The UE performs measurements for the set of beams and reports one or more beams having the best measurements from the set of beams. The P1 beam sweep may be performed with wider beams than P2 and P3, in some aspects. At P2, the network transmits a signal on a set of narrower beams over a narrower range, and the UE reports one or more beams to the base station from the set of narrower beams. At P3, the base station may transmit using a fixed beam (e.g., rather than the beams sweeps performed in P1 and P2), e.g., transmitting repeatedly using the same beam. The UE can then perform measurements in a beam sweep pattern to determine a receive beam, e.g., a spatial filter on a receiver antenna array.

The network may configure one or more TCI state configurations for the UE, and may indicate a TCI state for the UE from the configured set of TCI states. In some aspects, the UE may provide L1-SINR reporting, which may reduce overhead and latency and allow for CC group beam updates or faster UL beam updates. In some aspects, the UE may communicate with the network using unified TCI states, L1/L2 centric mobility (which may also be referred to a L1/L2 triggered mobility (LTM), dynamic TCI updates, and/or uplink multi-panel selection, maximum permissible exposure (MPE) migration. Beam management may be employed for particular scenarios, such as high speed (e.g., high speed train (HST)), single frequency network (SNF), multiple transmission reception points (mTRP), among other examples. Based on measurements, a UE may identify a beam failure detection (BFD) and may perform a beam failure recovery (BFD). In some aspects, the BFD or BFR may be for a primary cell (PCell) or a primary secondary cell (PSCell). BFD may be based on a BED reference signal (BFD-RS) and a PDCCH block error rate (BLER). The BFR may be based on a contention free random access (CFRA). For an SCell, the BFD and BFR may include a link recovery request via a scheduling request (SR), or a MAC-CE based BFR for the SCell. If the BFR is unsuccessful, the UE may identify a radio link failure.

Some wireless communication may include the use of AI or ML at the network and/or at the UE. Among various examples, AI/ML may be used for beam management at a UE and/or a network, including for performing beam predictions in a time domain and/or spatial domain. The use of an AI/ML model may reduce latency or overhead and may improve the accuracy of beam selection. Models may be provided that support various levels of network and UE collaboration and to support various use cases. The use of an AI/ML model may include various aspects such as model training, model deployment, model inference, model monitoring, and model updated.

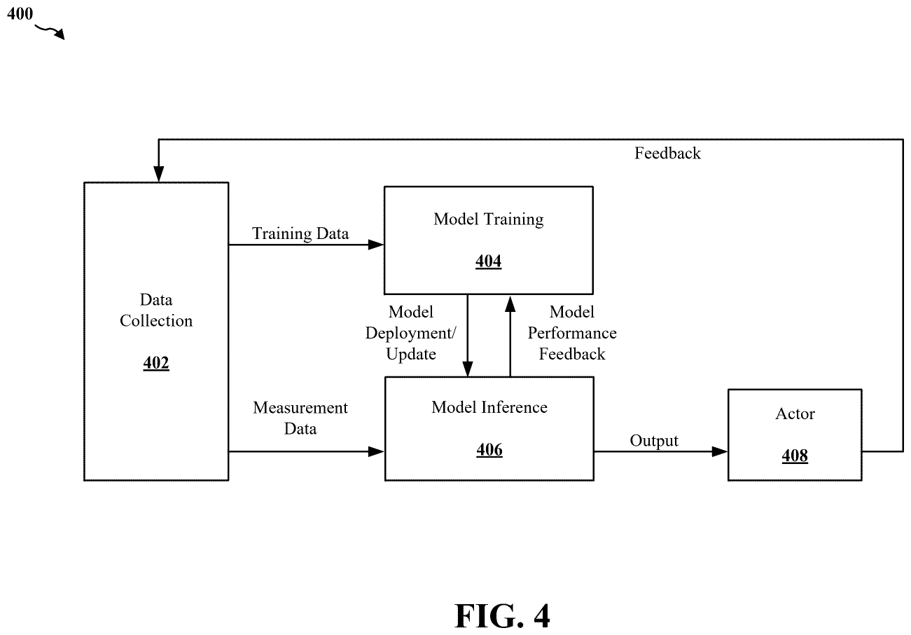

FIG. 4 is an example of the AI/ML algorithm 400 of a method of wireless communication and illustrates various aspects model training, model inference, model feedback, and model update. The AI/ML algorithm 400 may include various functions including a data collection 402, a model training function 404, a model inference function 406, and an actor 408.

The data collection 402 may be a function that provides input data to the model training function 404 and the model inference function 406. The data collection 402 function may include any form of data preparation, and it may not be specific to the implementation of the AI/ML algorithm (e.g., data pre-processing and cleaning, formatting, and transformation).

The examples of input data may include, but are not limited to, measurements, such as RSRP measurements, channel measurements, or other uplink/downlink transmissions, from entities including UEs or network nodes, feedback from the actor 408 (e.g., which may be a UE or network node), output from another AI/ML model. The data collection 402 may include training data, which refers to the data to be sent as the input for the AI/ML model training function 404, and inference data, which refers to be sent as the input for the AI/ML model inference function 406.

The model training function 404 may be a function that performs the ML model training, validation, and testing, which may generate model performance metrics as part of the model testing procedure. The model training function 404 may also be responsible for data preparation (e.g., data pre-processing and cleaning, formatting, and transformation) based on the training data delivered or received from the data collection 402 function. The model training function 404 may deploy or update a trained, validated, and tested AI/ML model to the model inference function 406, and receive a model performance feedback from the model inference function 406. As described above, there may be various functionalities to be performed by an AI/ML model for wireless communication

The model inference function 406 may be a function that provides the AI/ML model inference output (e.g., predictions or decisions). The model inference function 406 may also perform data preparation (e.g., data pre-processing and cleaning, formatting, and transformation) based on the inference data delivered from the data collection 402 function. The output of the model inference function 406 may include the inference output of the AI/ML model produced by the model inference function 406. The details of the inference output may be use case specific. As an example, the output may include a beam prediction for beam management. The prediction may be for the network or may be for the UE. In some aspects, the actor may be a component of the base station or of a core network. In other aspects, the actor may be a UE in communication with a wireless network.

The model performance feedback may refer to information derived from the model inference function 406 that may be suitable for the improvement of the AI/ML model trained in the model training function 404. The feedback from the actor 408 or other network entities (via the data collection 402 function) may be implemented for the model inference function 406 to create the model performance feedback.

The actor 408 may be a function that receives the output from the model inference function 406 and triggers or performs corresponding actions. The actor may trigger actions directed to network entities including the other network entities or itself. The actor 408 may also provide a feedback information that the model training function 404 or the model inference function 406 to derive training or inference data or performance feedback. The feedback may be transmitted back to the data collection 402.

The network may use machine-learning algorithms, deep-learning algorithms, neural networks, reinforcement learning, regression, boosting, or advanced signal processing methods for aspects of wireless communication including the various functionalities such as beam management, CSF, or positioning, among other examples.

In some aspects described herein, the network may train one or more neural networks to learn the dependence of measured qualities on individual parameters. Among others, examples of machine learning models or neural networks that may be included in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by the concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., any feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at the last layer of the neural network and may traverse layers multiple times.

For AI/ML based beam management, a spatial domain downlink beam prediction for a first set of beams may be based on measurement results of a second set of beam or a temporal downlink beam prediction for the first set of beams may be based on historic measurement results of the second set of beams may be utilized for characterizations and/or baseline performance evaluations. In some instances, the first set of beams and the second set of beams may be in the same frequency range. In some instances, the second set of beams may be a subset of the first set of beams. In some instances, the first set of beams and the second set of beams may be different. For example, the first set of beams may be comprised of narrow beams, while the second set of beams may be comprised of wide beams. The first set of beams may be utilized for downlink beam prediction, while the second set of beams may be utilized for downlink beam measurement.

In instances of spatial domain downlink beam prediction for the first set of beams based on the measurement results of the second set of beams, a UE may report information of the AI/ML model inference to the network. For example, the UE may report information related to one or more beams based on an output of the AI/ML model. In instances of temporal downlink beam prediction for the first set of beams based on the historic measurement results of the second set of beams, a UE may report information related to one or more beams of future time instances that may be based on the output of the AI/ML model. In instances where beam prediction is comprised of spatial domain downlink beam prediction and temporal downlink beam prediction, a UE may perform UE-side model monitoring or the network may perform network-side model monitoring. For example, for UE-side model monitoring, the UE may monitor performance metrics, make decisions of model selection, activation, deactivation, switching, or fallback operations. For network-side model monitoring, the network may monitor performance metrics or make decisions of model selection, activation, deactivation, switching, or fallback operations. In some instances, a hybrid model monitoring approach may take place, where a UE monitors the performance metrics, while the network makes decisions of model selection, activation, deactivation, switching, or fallback operations.

In instances where beam prediction is comprised of spatial domain downlink beam prediction and temporal downlink beam prediction and includes a network-side AI/ML model, the network may monitor the performance metrics and make decisions of model selection, activation, deactivation, switching, or fallback operation. In such instances, the network may monitor beam measurements for model monitoring. In such instances, a UE may report measurement results of a plurality of beams in one reporting instance with regards to layer 1 (L1) beam reporting enhancement for AI/ML model inference.

In wireless communications, beam prediction may be inaccurate due to insufficient measurements or observations. In some instances, DMRS and CSI-RS may be utilized to improve the prediction accuracy. For example, DMRS may be utilized for more opportunistic measurement resources, or more opportunistic performance monitoring occasions may be based on DMRS transmitted via the same beam as the UE predicted beam based on L1-RSRPs in an effort to verify the UE predicted L1-RSRPs. In some instances, aperiodic CSI-RS (AP CSI-RS) may also be utilized to improve the prediction accuracy. For example, AP CSI-RS transmitted via the same beam that has been used by the UE as AI/ML input for beam prediction may also be used to refine or improve beam prediction accuracy. In another example, AP CSI-RS transmitted via the same beam as the UE predicted beam based on L1-RSRPs may be use to verify the UE predicted L1-RSRPs.

In some instances, QCL Type D may be associated with spatial reception parameters, but not associated with spatial transmission parameters. QCL Type D may be associated with spatial reception parameters, and base station implementation may determine the associated spatial transmission parameters. For example, the base station may utilize a beam that is narrower than the QCL-source in order to improve throughput. However, a UE may not assume that the same transmission beam is used for transmitting the DMRS/CSI-RS QCL Type D source reference signal. The UE may derive the receive beam for receiving such DMRS/CSI-RS based on the reception beam that has been used to receive the corresponding QCL Type D source reference signal. As such, the UE may not assume that such DMRS/CSI-RS may be used as additional AI/ML inputs, nor used as prediction verification resource. Aspects presented herein provide for a new or modified QCL type to define spatial transmission parameters.

Aspects presented herein provide for an accuracy improvement for opportunistic DMRS or CSI-RS aided beam prediction. The aspects presented herein may allow for an improvement of beam prediction accuracy based on spatial transmission parameters. The aspects presented herein may enable a UE to receive a TCI state configuration that corresponds to a target reference signal including at least one QCL configuration. The at least one QCL configuration may comprise spatial transmission parameters that are shared with a source signal. The UE may receive the target referenced signal that corresponds with the TCI state configuration, such that a transmission spatial filter of the target reference signal corresponds to the source signal.

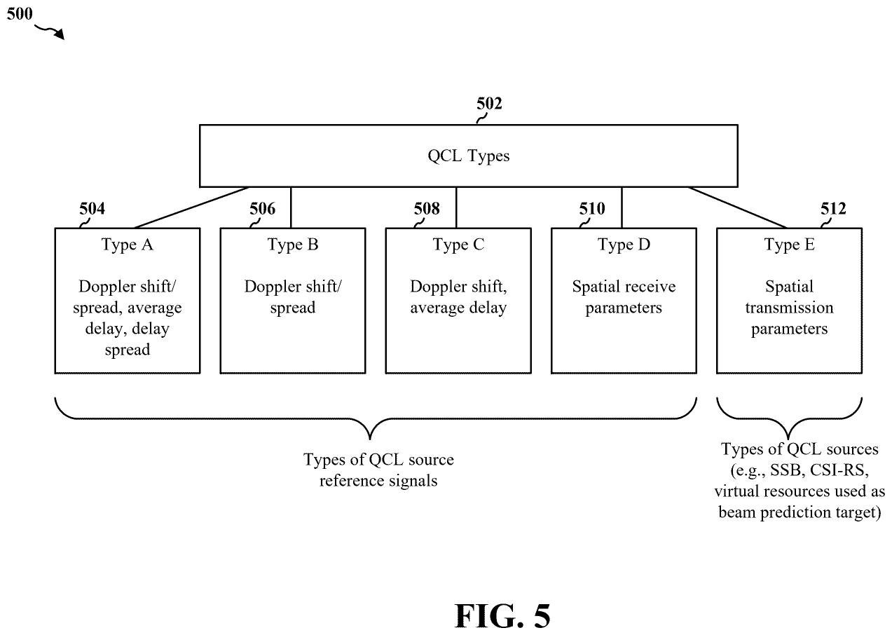

FIG. 5 is a diagram 500 of QCL types. The QCL types 502 may comprise Type A 504, Type B 506, Type C 508, Type D 510, and Type E 512. Type A 504 may comprise information related to Doppler shift, Doppler spread, an average delay, or a delay spread. Type B 506 may comprise information related to Doppler shift or Doppler spread. Type C 508 may comprise information related to Doppler shift or average delay. Type D 510 may comprise information related to spatial receive parameters. Type E 512 may comprise information related to spatial transmission parameters. The QCL Types A-D may be types of QCL source reference signals (e.g., SSBs or CSI-RSs). The QCL Type E may also be a type of QCL sources (e.g., SSBs or CSI-RSs) that may be utilized as additional and/or opportunistic AI/ML input, but may also comprise virtual resources that are not transmitted beforehand, but may be used as UE beam prediction targets, that may be utilized as opportunistic AI/ML performance monitoring.

In some aspects, a UE may be configured to identify a QCL Type E from a TCI state configuration, such that for a target DMRS/CSI-RS associated with a TCI state comprising QCL Type E, the UE may expect that the target DMRS/CSI-RS comprises identical or equivalent spatial transmission parameters as the spatial transmission parameters used for transmitting the associated QCL Type E source configured in the corresponding TCI state. The target reference signal (e.g., DMRS) may be associated with a PDCCH or a PDSCH. The QCL Type E source may comprise a SSB, a periodic or semi-periodic CSI-RS, or a virtual resource (e.g., a resource that is not actually transmitted). In some aspects, a RRC, MAC-CE, or DCI TCI state configuration may be reused to identify the QCL Type E.

In some aspects, The QCL Type E source of a TCI state may be a virtual resource (e.g., a resource that has not been actually transmitted), but may be reported by the UE along with predicted channel characteristics. The predicted channel characteristics may include one or more of predicted L1 RSRP, L1 SINR, RI, CQI, PMI, or being one of the top predicted resources. The virtual resource may be utilized for opportunistic AI/ML performance monitoring. In some aspects, the QCL Type E source of a TCI state may comprise a SSB or CSI-RS that has been configured or indicated by the network for channel measurement, or alternatively as a prediction target. The SSB or CSI-RS that has been configured or indicated by the network for channel measurement or a prediction target may be utilized for additional or opportunistic AI/ML input or performance monitoring.

In some aspects, UE capabilities may be related with respect to improving the accuracy of DMRS-based beam prediction. For example, the UE may be configured to report its supporting capabilities on QCL Type E. In some instances, the UE may indicate support a first capability for QCL Type E with a source comprising virtual resources that have not been transmitted by the network. In such instances, the UE may be able to carry out opportunistic AI/ML performance monitoring, but its AI/ML models may not take opportunistic measurements as inputs. In some instances, the UE may indicate support for a second capability for QCL Type E with a source comprising SSB or CSI-RS. In such instances, the UE may be able to take opportunistic measurements as inputs, but is unable to carry out opportunistic AI/ML performance monitoring. In some instances, the UE may indicate support for a third capability for QCL Type E with a source comprising either SSB/CSI-RS or virtual resources that have not been transmitted by the network. In such instances, the UE may be able to both take opportunistic measurements as inputs and also carry out opportunistic AI/ML performance monitoring. In some instances, the UE may indicate a fourth capability indicating a lack of support for QCL Type E. In such instances, UE is unable to take opportunistic measurements as inputs or carry out opportunistic AI/ML performance monitoring.

In some aspects, the UE capabilities may be reported per frequency range, per component carrier, or per bandwidth part. In some aspects, the UE capabilities may be reported per AI/ML use case, scenario, or functionality, or based on AI/ML operation modes, parameters, or details. For example, the UE capabilities may indicate support time domain beam prediction but do not provide support for spatial domain or frequency domain prediction. In another example, the UE capabilities may indicate support for instances when the source reference signal or source virtual resource is conveyed by a beamwidth of a specific range (e.g., less than 15 degrees). In another example, the UE capabilities may indicate support for instances where the UE has addressed the virtual resource in a prediction report (e.g., within a certain predefined window), otherwise if the virtual resource has not been addressed (e.g., within the predefined window) then support is not present.

In some aspects, if the UE reports support for the first, second, or third capability, discussed above, then the UE may further report a maximum number of TCI states with QCL Type E that may be simultaneously activated via MAC-CE. For example, if the third capability is reported as being supported, the maximum number of TCI states with QCL Type E that may be simultaneously activated via MAC-CE may be based on a reporting of a first maximum number taking both SSBs/CSI-RSs as QCL Type E source type, as well as virtual resource. The UE may then report a second maximum number, that is less than the first maximum number, by taking SSBs/CSI-RSs as QCL Type E source type into account, and/or report a third maximum number, which is less than the second number, by taking virtual resources as QCL Type E source type into account, such that the MAC-CE activated TCI states with respect to QCL Type E do not violate any of the reported maximum numbers. In another example, if the third capability is reported as being supported, the maximum number of TCI states with QCL Type E that may be simultaneously activated via MAC-CE may be based on a reporting of a single maximum number taking both SSBs/CSI-RSs as QCL Type E source type, as well as virtual resources into account, such that the MAC-CE activated TCI state with respect to QCL Type E do not violate the single maximum number. The arrangement among SSBs/CSI-RSs and virtual resources among such MAC-CE activated TCI states with respect to QCL Type E may be determined by network implementation.

In instances where the first capability is reported as being supported, a single maximum number or virtual resources taken into account may be reported, such that the MAC-CE activated TCI states with respect to QCL Type E do not violate the reported maximum number. In instances where the second capability is reported as being supported, a single maximum number taking SSBs/CSI-RSs into account may be reported, such that the MAC-CE activated TCI states with respect to QCL Type E do not violate the reported maximum number. In some aspects, the maximum number of TCI states with QCL Type E that may be simultaneously MAC-CE activated may be preconfigured or predefined. For example, the preconfigured or predefined maximum number may be based on different maximum numbers for different functionalities, use-cases, scenarios. In some aspects, when a TCI state with QCL Type E is activated, the UE may be configured to activate additional AI/ML model inference features, such as but not limited to opportunistic measurements based on additional or alternative AI/ML model which may consume higher power. As such, the maximum number of TCI states with QCL Type E that may be activated simultaneously may be a UE capability or may be preconfigured.

In some aspects, the UE may request, proactively, to receive the target reference signal (e.g., DMRS or CSI-RS) based on the QCL Type E. The UE may request from the network whether the UE would request the target reference signal (e.g., DMRS or CSI-RS) to be signaled based on QCL Type E. For example, the UE may utilize MAC-CE or UCI to send such request to the network. The UE may utilize the CSI report comprising the beam prediction results to indicate, to the network, whether the UE is to receive a PDSCH having a DMRS with a QCL Type E with the connection management requests (CMRs) or prediction targets with respect to the corresponding CSI report setting. The indication transmitted to the network to indicate the manner in which the UE is to receive the PDSCH may be comprised in an additional report (e.g., reportQuantity), which may be configured by the associated CSI report setting. In some aspects, the UE may transmit the request for target channels of PDSCH-DMRS, or PDCCH-DMRS, or CSI-RS, or any combination thereof. The request may comprise periodic, semi-periodic, or aperiodic CSI-RS requests. In some aspects, the UE may use the CSI report comprising the beam prediction results to indicate whether the UE is to receive a PDSCH having a DMRS with QCL Type E with the CMRs or prediction targets with respect to the corresponding CSI report setting. The indication transmitted to the network to indicate the manner in which the UE is to receive the PDSCH may be comprised in an additional report (e.g., reportQuantity), which can be configured by the associated CSI report setting. In some aspects, the UE may utilize a bitmap where each bit of the bitmap is associated with a certain component that may be used to transmit such request. In some aspects, the UE may utilize a dedicated MAC-CE to transmit the request. The MAC-CE may indicate a specific CMR identifier (ID) or virtual resource IDs that the UE may request to be addressed as a QCL Type E source Sfor the corresponding DMRS/CSI-RS.

In some aspects, the UE may request, proactively, to disable the QCL Type E. The UE may request to disable the QCL Type E for certain channels. The UE may request to disable the QCL Type E in similar manners as requesting to receive the target reference signal (e.g., DMRS or CSI-RS). In some aspects, if the UE does not request or desire the QCL Type E, (e.g., if the prediction is already very confident without such additional DMRS/CSI-RS), the network may be more flexible on using its transmission beams (e.g., using narrower beams for better throughput). As such, the UE proactively requested enabling/disabling QCL Type E may assist the network or the UE to achieve better end-to-end performance.

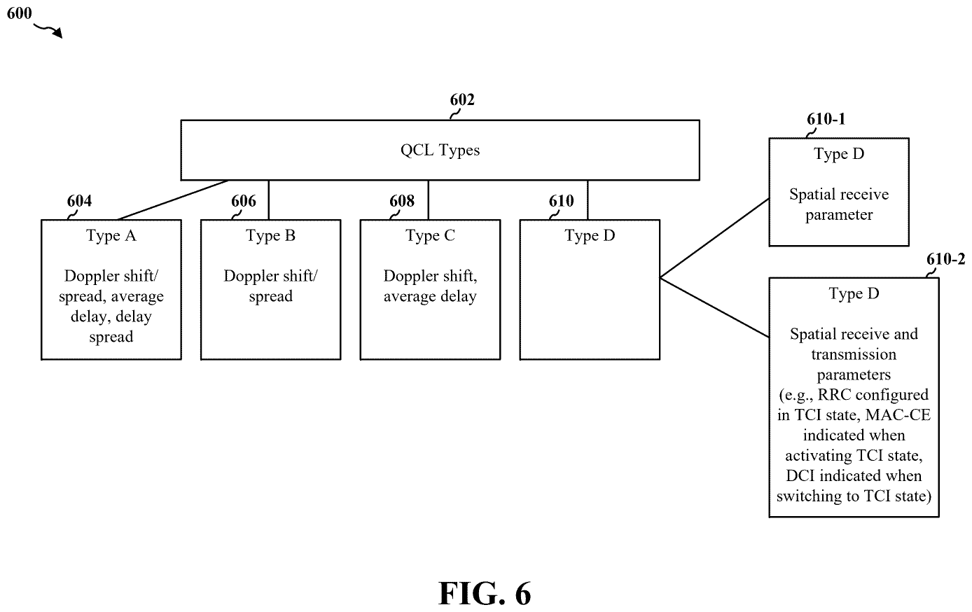

FIG. 6 is a diagram 600 of QCL types. The QCL types 602 may comprise Type A 604, Type B 606, Type C 608, and Type D 610. Type A 604 may comprise information related to Doppler shift, Doppler spread, an average delay, or a delay spread. Type B 606 may comprise information related to Doppler shift or Doppler spread. Type C 608 may comprise information related to Doppler shift or average delay. Types A-C of FIG. 6 are similar to Types A-C of FIG. 5. However, Type D 610 may comprise Type D 610-1 that comprises information related to spatial receive parameters, and may also comprise Type D 610-2 that may comprise information related to spatial receive parameters and spatial transmission parameters. Type D 610-2 may indicate whether spatial transmission parameters are included along with the spatial receive parameters. Type D 610 of FIG. 6 may be configured to have Type D 610-1 and/or Type D 610-2. Type D 610-2 may be configured similarly as Type E 512 of FIG. 5.

Type D 610-2 may indicate whether spatial transmission parameters are included based on at least one of RRC signaling, MAC-CE, or DCI. For example, RRC signaling, MAC-CE, or DCI may be utilized to identify spatial transmission parameters. In some aspects, when configuring a TCI-state, via RRC, with respect to at least the QCL Type D, the TCI state may comprise additional information or sub-information elements indicating whether the UE should interpret the target reference signal (e.g., DMRS or CSI-RS) as comprising identical or equivalent spatial transmission parameters as the spatial transmission parameters used for transmitting the associated QCL Type D source configured in the corresponding TCI state. In some aspects, when activating a TCI state, via MAC-CE, with respect to at least the QCL Type D, the MAC-CE may indicate whether the UE should interpret the target reference signal (e.g., DMRS or CSI-RS) as comprising identical or equivalent spatial transmission parameters as the spatial transmission parameters used for transmitting the associated QCL Type D source configured in the corresponding TCI state. In some aspects, when switching to a TCI state, via DCI, with respect to at least the QCL Type D, the DCI may indicate whether the UE should interpret the target reference signal e.g., (DMRS or CSI-RS) as comprising identical or equivalent spatial transmission parameters as the spatial transmission parameters used for transmitting the associated QCL Type D source configured in the corresponding TCI state. Use of the RRC, MAC-CE, or DCI to indicate the spatial transmission parameters may be used jointly or independently. For example, MAC-CE may overwrite the transmission parameters indicated via RRC, while DCI may overwrite the transmission parameters indicated via RRC and/or MAC-CE.

In some aspects, The QCL Type D source of a TCI state may be a virtual resource (e.g., a resource that has not been actually transmitted), but may be reported by the UE along with predicted channel characteristics. The predicted channel characteristics may include one or more of predicted L1 RSRP, L1 SINR, RI, CQI, PMI, or being one of the top predicted resources. The virtual resource may be utilized for opportunistic AI/ML performance monitoring. In some aspects, the QCL Type D source of a TCI state may comprise a SSB or CSI-RS that has been configured or indicated by the network for channel measurement, or alternatively as a prediction target. The SSB or CSI-RS that has been configured or indicated by the network for channel measurement or a prediction target may be utilized for additional or opportunistic AI/ML input or performance monitoring.

In some aspects, UE capabilities may be related with respect to improving the accuracy of DMRS-based beam prediction. For example, the UE may be configured to report its supporting capabilities on QCL Type D. In some instances, the UE may indicate support a first capability for QCL Type D with a source comprising virtual resources that have not been transmitted by the network. In such instances, the UE may be able to carry out opportunistic AI/ML performance monitoring, but its AI/ML models may not take opportunistic measurements as inputs. In some instances, the UE may indicate support for a second capability for QCL Type D with a source comprising SSB or CSI-RS. In such instances, the UE may be able to take opportunistic measurements as inputs, but is unable to carry out opportunistic AI/ML performance monitoring. In some instances, the UE may indicate support for a third capability for QCL Type D with a source comprising either SSB/CSI-RS or virtual resources that have not been transmitted by the network. In such instances, the UE may be able to both take opportunistic measurements as inputs and also carry out opportunistic AI/ML performance monitoring. In some instances, the UE may indicate a fourth capability indicating a lack of support for QCL Type D. In such instances, UE is unable to take opportunistic measurements as inputs or carry out opportunistic AI/ML performance monitoring.

In some aspects, the UE capabilities may be reported per frequency range, per component carrier, or per bandwidth part. In some aspects, the UE capabilities may be reported per AI/ML use case, scenario, or functionality, or based on AI/ML operation modes, parameters, or details. For example, the UE capabilities may indicate support time domain beam prediction but do not provide support for spatial domain or frequency domain prediction. In another example, the UE capabilities may indicate support for instances when the source reference signal or source virtual resource is conveyed by a beamwidth of a specific range (e.g., less than 15 degrees). In another example, the UE capabilities may indicate support for instances where the UE has addressed the virtual resource in a prediction report (e.g., within a certain predefined window), otherwise if the virtual resource has not been addressed (e.g., within the predefined window) then support is not present.

In some aspects, if the UE reports support for the first, second, or third capability, discussed above, then the UE may further report a maximum number of TCI states with QCL Type D that may be simultaneously activated via MAC-CE. For example, if the third capability is reported as being supported, the maximum number of TCI states with QCL Type D that may be simultaneously activated via MAC-CE may be based on a reporting of a first maximum number taking both SSBs/CSI-RSs as QCL Type D source type, as well as virtual resource. The UE may then report a second maximum number, that is less than the first maximum number, by taking SSBs/CSI-RSs as QCL Type D source type into account, and/or report a third maximum number, which is less than the second number, by taking virtual resources as QCL Type D source type into account, such that the MAC-CE activated TCI states with respect to QCL Type D do not violate any of the reported maximum numbers. In another example, if the third capability is reported as being supported, the maximum number of TCI states with QCL Type D that may be simultaneously activated via MAC-CE may be based on a reporting of a single maximum number taking both SSBs/CSI-RSs as QCL Type D source type, as well as virtual resources into account, such that the MAC-CE activated TCI state with respect to QCL Type D do not violate the single maximum number. The arrangement among SSBs/CSI-RSs and virtual resources among such MAC-CE activated TCI states with respect to QCL Type D may be determined by network implementation.

In instances where the first capability is reported as being supported, a single maximum number or virtual resources taken into account may be reported, such that the MAC-CE activated TCI states with respect to QCL Type D do not violate the reported maximum number. In instances where the second capability is reported as being supported, a single maximum number taking SSBs/CSI-RSs into account may be reported, such that the MAC-CE activated TCI states with respect to QCL Type D do not violate the reported maximum number. In some aspects, the maximum number of TCI states with QCL Type D that may be simultaneously MAC-CE activated may be preconfigured or predefined. For example, the preconfigured or predefined maximum number may be based on different maximum numbers for different functionalities, use-cases, scenarios. In some aspects, when a TCI state with QCL Type D is activated, the UE may be configured to activate additional AI/ML model inference features, such as but not limited to opportunistic measurements based on additional or alternative AI/ML model which may consume higher power. As such, the maximum number of TCI states with QCL Type D that may be activated simultaneously may be a UE capability or may be preconfigured.

In some aspects, the UE may request, proactively, to receive the target reference signal (e.g., DMRS or CSI-RS) based on the QCL Type D. The UE may request from the network whether the UE would request the target reference signal (e.g., DMRS or CSI-RS) to be signaled based on QCL Type D. For example, the UE may utilize MAC-CE or UCI to send such request to the network. The UE may utilize the CSI report comprising the beam prediction results to indicate, to the network, whether the UE is to receive a PDSCH having a DMRS with a QCL Type D with the CMRs or prediction targets with respect to the corresponding CSI report setting. The indication transmitted to the network to indicate the manner in which the UE is to receive the PDSCH may be comprised in an additional report (e.g., reportQuantity), which may be configured by the associated CSI report setting. In some aspects, the UE may transmit the request for target channels of PDSCH-DMRS, or PDCCH-DMRS, or CSI-RS, or any combination thereof. The request may comprise periodic, semi-periodic, or aperiodic CSI-RS requests. In some aspects, the UE may use the CSI report comprising the beam prediction results to indicate whether the UE is to receive a PDSCH having a DMRS with QCL Type D with the CMRs or prediction targets with respect to the corresponding CSI report setting. The indication transmitted to the network to indicate the manner in which the UE is to receive the PDSCH may be comprised in an additional report (e.g., reportQuantity), which can be configured by the associated CSI report setting. In some aspects, the UE may utilize a bitmap where each bit of the bitmap is associated with a certain component that may be used to transmit such request. In some aspects, the UE may utilize a dedicated MAC-CE to transmit the request. The MAC-CE may indicate a specific CMR identifier (ID) or virtual resource IDs that the UE may request to be addressed as a QCL Type D source S for the corresponding DMRS/CSI-RS.

In some aspects, the UE may request, proactively, to disable the QCL Type D. The UE may request to disable the QCL Type D for certain channels. The UE may request to disable the QCL Type D in similar manners as requesting to receive the target reference signal (e.g., DMRS or CSI-RS). In some aspects, if the UE does not request or desire the QCL Type D, (e.g., if the prediction is already very confident without such additional DMRS/CSI-RS), the network may be more flexible on using its transmission beams (e.g., using narrower beams for better throughput). As such, the UE proactively requested enabling/disabling QCL Type D may assist the network or the UE to achieve better end-to-end performance.

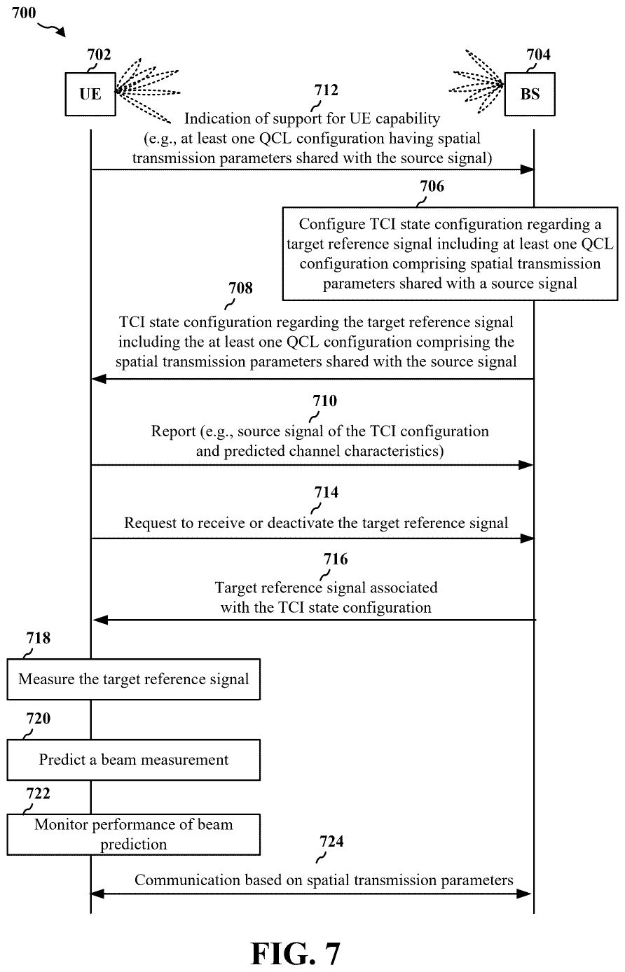

FIG. 7 is a call flow diagram 700 of signaling between a UE 702 and a base station 704. The base station 704 may be configured to provide at least one cell. The UE 702 may be configured to communicate with the base station 704. For example, in the context of FIG. 1, the base station 704 may correspond to base station 102 and the UE 702 may correspond to at least UE 104. In another example, in the context of FIG. 3, the base station 704 may correspond to base station 310 and the UE 702 may correspond to UE 350.

At 706, the base station 704 may configure a TCI state configuration that may be regarding or corresponding to a target reference signal including at least one QCL configuration comprising spatial transmission parameters shared with a source signal. In some aspects, the at least one QCL configuration may comprise a QCL Type D configuration. At least one of a MAC-CE, RRC signaling, or DCI associated with the QCL Type D configuration may indicate that the target reference signal corresponds to the spatial transmission parameters used for transmission of the source signal of the Type D configuration in the TCI state configuration. In some aspects, the at least one QCL configuration comprises a QCL Type E, where the QCL Type E may include spatial transmission parameters.

At 708, the base station 704 may provide, to the UE 702, the TCI state configuration regarding the target reference signal including the at least one QCL configuration comprising the spatial transmission parameters shared with the source signal. The base station may provide, to the UE, the TCI state configuration regarding the target reference signal including the at least one QCL configuration comprising the spatial transmission parameters shared with the source signal. The UE 702 may receive the TCI state configuration regarding the target reference signal including the at least one QCL configuration comprising the spatial transmission parameters shared with the source signal from the base station 704.

At 710, the UE 702 may transmit a report for the source signal of the TCI configuration and predicted channel characteristics. The UE may transmit the report for the source signal of the TCI configuration and predicted channel characteristics to the base station 704. The base station may obtain the report from the UE 702. For example, the predicted channel characteristics may include a predicted layer 1 (L1) reference signal received power (RSRP), L1 signal to interference plus noise ratio (SINR), rank indicator (RI), channel quality indicator (CQI), precoding matrix indicator (PMI), or being one of a predicted top resources.

At 712, the UE 702 may transmit an indication of support for a UE capability associated with the at least one QCL configuration that may comprise the spatial transmission parameters shared with the source signal. The UE may transmit the indication of support for the UE capability to the base station 704. The base station 704 may obtain the indication of support for the UE capability from the UE 702. In some aspects, the UE capability may indicate at least one of support for the at least one QCL configuration comprising virtual resources, support for the at least one QCL configuration comprising a source based on synchronization signal block (SSB) or channel state information reference signal (CSI-RS), support for the at least one QCL configuration comprising the virtual resources or the source based on the SSB or the CSI-RS, or a lack of support for the at least one QCL configuration. In some aspects, the support for the UE capability may be indicated for at least one of a use case scenario or functionality with regards to the at least one QCL configuration. In some aspects, the UE capability may indicate a maximum number of MAC-CE activated TCI states with the at least one QCL configuration that comprises the spatial transmission parameters shared with the source signal.

At 714, the UE 702 may transmit a request to receive or deactivate the target reference signal. The UE may transmit the request to receive or deactivate the target reference signal to the base station 704. The UE may transmit the request to receive or deactivate the target reference signal based on the at least one QCL configuration that comprises the spatial transmission parameters shared with the source signal. In some aspects, the request may be transmitted via MAC-CE or uplink control information (UCI). In some aspects, the request may correspond to target channels of the target reference signal.

At 716, the base station 704 may provide the target reference signal associated with the TCI state configuration. The base station may provide the target reference signal associated with the TCI state configuration to the UE 702. The UE 702 may receive the target reference signal associated with the TCI state configuration from the base station 704. A transmission spatial filter of the target reference signal may correspond to the source signal from the TCI state configuration. In some aspects, the transmission spatial filter of the target reference signal may be identical or equivalent to the source signal of the at least one QCL configuration.

At 718, the UE 702 may measure the target reference signal. At 720, the UE 702 may predict a beam measurement based on the transmission spatial filter of the target reference signal corresponding to the source signal of the at least one QCL configuration. In some aspects, an accuracy of a beam prediction may be refined based at least on the at least one QCL configuration from the TCI state configuration regarding the target reference signal.

At 722, the UE 702 may monitor performance of a beam prediction based at least on the at least one QCL configuration from the TCI state configuration regarding the target reference signal.

After measuring, predicting, and/or reporting beam information at 718, 720, and 722, the UE may communicate with the base station 704 using the QCL configuration for a TCI state that indicates the spatial transmissions parameters of the communication, at 724.

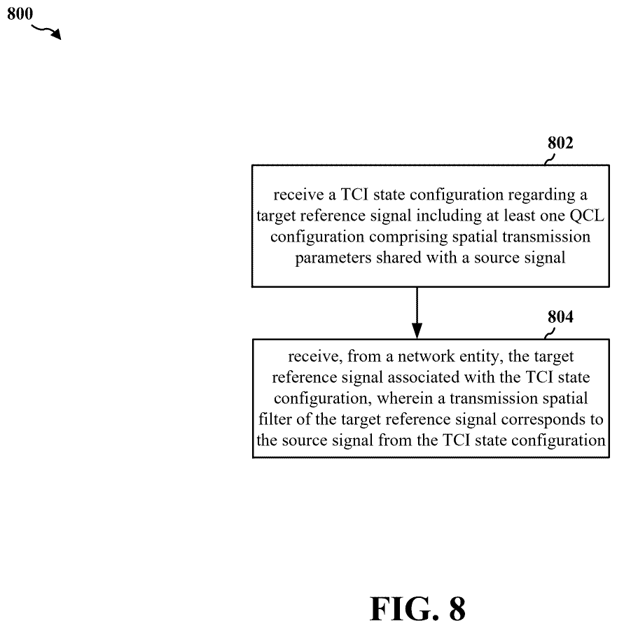

FIG. 8 is a flowchart 800 of a method of wireless communication. The method may be performed by a UE (e.g., the UE 104; the apparatus 1004). One or more of the illustrated operations may be omitted, transposed, or contemporaneous. The method may allow for an improvement of beam prediction accuracy based on spatial transmission parameters.

At 802, the UE may receive a TCI state configuration. For example, 802 may be performed by QCL component 198 of apparatus 1004. The TCI state configuration may be regarding a target reference signal including at least one QCL configuration comprising spatial transmission parameters shared with a source signal. In some aspects, the at least one QCL configuration may comprise a QCL Type D configuration. At least one of a MAC-CE, RRC signaling, or DCI associated with the QCL Type D configuration may indicate that the target reference signal corresponds to the spatial transmission parameters used for transmission of the source signal of the Type D configuration in the TCI state configuration. In some aspects, the at least one QCL configuration comprises a QCL Type E, where the QCL Type E may include spatial transmission parameters.

At 804, the UE may receive the target reference signal associated with the TCI state configuration. For example, 804 may be performed by QCL component 198 of apparatus 1004. The UE may receive the target reference signal associated with the TCI state configuration from a network entity. A transmission spatial filter of the target reference signal may correspond to the source signal from the TCI state configuration. In some aspects, the transmission spatial filter of the target reference signal may be identical or equivalent to the source signal of the at least one QCL configuration.

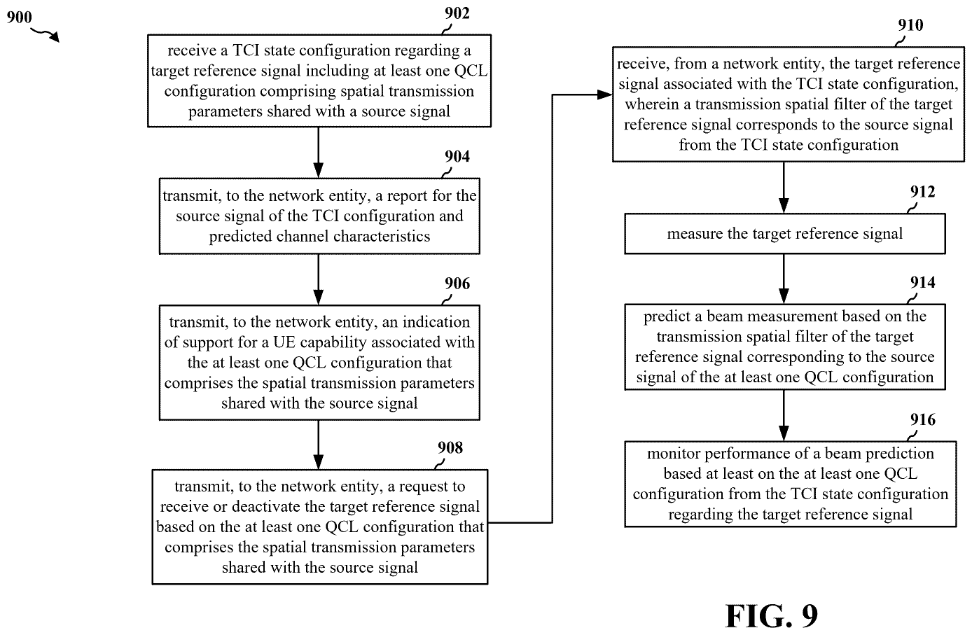

FIG. 9 is a flowchart 900 of a method of wireless communication. The method may be performed by a UE (e.g., the UE 104; the apparatus 1004). One or more of the illustrated operations may be omitted, transposed, or contemporaneous. The method may allow for an improvement of beam prediction accuracy based on spatial transmission parameters.

At 902, the UE may receive a TCI state configuration. For example, 902 may be performed by QCL component 198 of apparatus 1004. The TCI state configuration may be regarding a target reference signal including at least one QCL configuration comprising spatial transmission parameters shared with a source signal. In some aspects, the at least one QCL configuration may comprise a QCL Type D configuration. At least one of a MAC-CE, RRC signaling, or DCI associated with the QCL Type D configuration may indicate that the target reference signal corresponds to the spatial transmission parameters used for transmission of the source signal of the Type D configuration in the TCI state configuration. In some aspects, the at least one QCL configuration comprises a QCL Type E, where the QCL Type E may include spatial transmission parameters.

At 904, the UE may transmit a report for the source signal of the TCI configuration and predicted channel characteristics. For example, 904 may be performed by QCL component 198 of apparatus 1004. The UE may transmit the report for the source signal of the TCI configuration and predicted channel characteristics to the network entity. For example, the predicted channel characteristics may include a predicted L1 RSRP, L1 SINR, RI, CQI, PMI, or being one of a predicted top resources.

At 906, the UE may transmit an indication of support for a UE capability associated with the at least one QCL configuration that may comprise the spatial transmission parameters shared with the source signal. For example, 906 may be performed by QCL component 198 of apparatus 1004. The UE may transmit the indication of support for the UE capability to the network entity. In some aspects, the UE capability may indicate at least one of support for the at least one QCL configuration comprising virtual resources, support for the at least one QCL configuration comprising a source based on SSB or CSI-RS, support for the at least one QCL configuration comprising the virtual resources or the source based on the SSB or the CSI-RS, or a lack of support for the at least one QCL configuration. In some aspects, the support for the UE capability may be indicated for at least one of a use case scenario or functionality with regards to the at least one QCL configuration. In some aspects, the UE capability may indicate a maximum number of MAC-CE activated TCI states with the at least one QCL configuration that comprises the spatial transmission parameters shared with the source signal.

At 908, the UE may transmit a request to receive or deactivate the target reference signal. For example, 908 may be performed by QCL component 198 of apparatus 1004. The UE may transmit the request to receive or deactivate the target reference signal to the network entity. The UE may transmit the request to receive or deactivate the target reference signal based on the at least one QCL configuration that comprises the spatial transmission parameters shared with the source signal. In some aspects, the request may be transmitted via MAC-CE or UCI. In some aspects, the request may correspond to target channels of the target reference signal.

At 910, the UE may receive the target reference signal associated with the TCI state configuration. For example, 910 may be performed by QCL component 198 of apparatus 1004. The UE may receive the target reference signal associated with the TCI state configuration from a network entity. A transmission spatial filter of the target reference signal may correspond to the source signal from the TCI state configuration. In some aspects, the transmission spatial filter of the target reference signal may be identical or equivalent to the source signal of the at least one QCL configuration.

At 912, the UE may measure the target reference signal. For example, 912 may be performed by QCL component 198 of apparatus 1004.

At 914, the UE may predict a beam measurement. For example, 914 may be performed by QCL component 198 of apparatus 1004. The UE may predict the beam measurement based on the transmission spatial filter of the target reference signal corresponding to the source signal of the at least one QCL configuration. In some aspects, an accuracy of a beam prediction may be refined based at least on the at least one QCL configuration from the TCI state configuration regarding the target reference signal.

At 916, the UE may monitor performance of a beam prediction. For example, 916 may be performed by QCL component 198 of apparatus 1004. The UE may monitoring performance of the beam prediction based at least on the at least one QCL configuration from the TCI state configuration regarding the target reference signal.

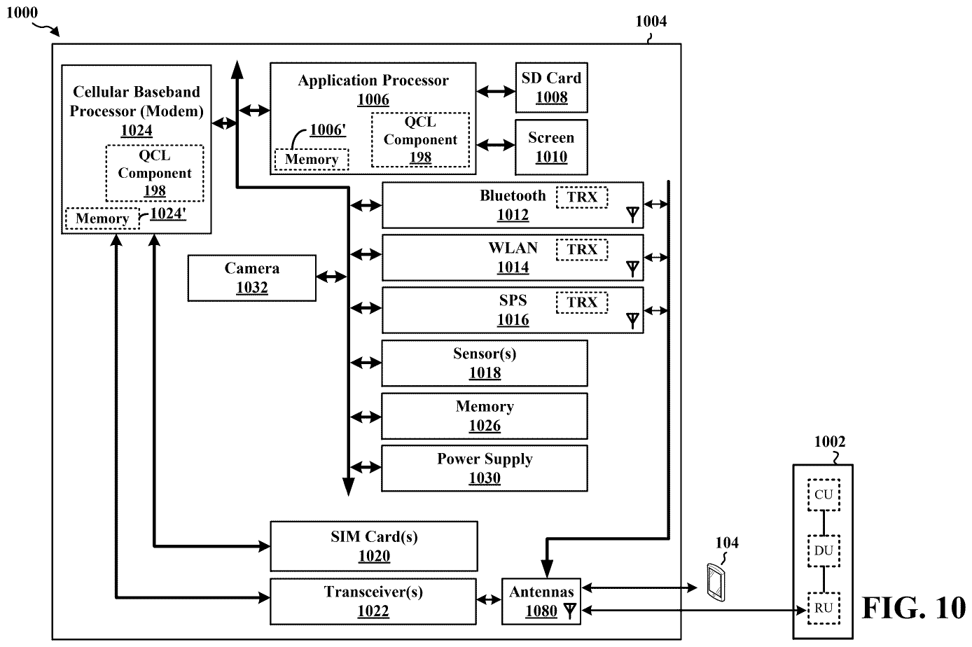

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed supra, the component 198 is configured to receive a TCI state configuration regarding a target reference signal including at least one QCL configuration comprising spatial transmission parameters shared with a source signal; and receive, from a network entity, the target reference signal associated with the TCI state configuration, wherein a transmission spatial filter of the target reference signal corresponds to the source signal from the TCI state configuration. The component 198 may be within the cellular baseband processor 1024, the application processor 1006, or both the cellular baseband processor 1024 and the application processor 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for receiving a TCI state configuration regarding a target reference signal including at least one QCL configuration comprising spatial transmission parameters shared with a source signal. The apparatus includes means for receiving, from a network entity, the target reference signal associated with the TCI state configuration, wherein a transmission spatial filter of the target reference signal corresponds to the source signal from the TCI state configuration. The apparatus further includes means for transmitting, to the network entity, a report for the source signal of the TCI configuration and predicted channel characteristics. The apparatus further includes means for transmitting, to the network entity, an indication of support for a UE capability associated with the at least one QCL configuration that comprises the spatial transmission parameters shared with the source signal. The apparatus further includes means for transmitting, to the network entity, a request to receive or deactivate the target reference signal based on the at least one QCL configuration that comprises the spatial transmission parameters shared with the source signal. The apparatus further includes means for measuring the target reference signal. The apparatus further includes means for predicting a beam measurement based on the transmission spatial filter of the target reference signal corresponding to the source signal of the at least one QCL configuration. The apparatus further includes means for monitoring performance of a beam prediction based at least on the at least one QCL configuration from the TCI state configuration regarding the target reference signal. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

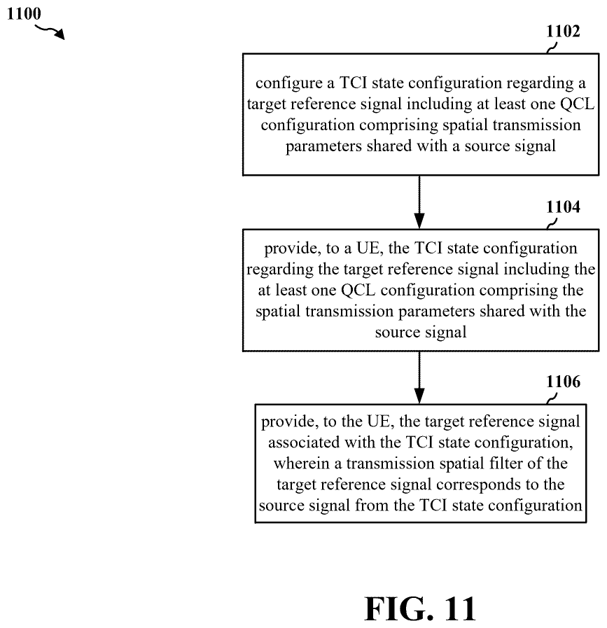

FIG. 11 is a flowchart 1100 of a method of wireless communication. The method may be performed by a base station (e.g., the base station 102; the network entity 1302. One or more of the illustrated operations may be omitted, transposed, or contemporaneous. The method may configure a UE to improve beam prediction accuracy based on spatial transmission parameters.

At 1102, the network entity may configure a TCI state configuration. For example, 1102 may be performed by QCL component 199 of network entity 1302. The TCI state configuration may be regarding a target reference signal including at least one QCL configuration comprising spatial transmission parameters shared with a source signal. In some aspects, the at least one QCL configuration may comprise a QCL Type D configuration. At least one of a MAC-CE, RRC signaling, or DCI associated with the QCL Type D configuration may indicate that the target reference signal corresponds to the spatial transmission parameters used for transmission of the source signal of the Type D configuration in the TCI state configuration. In some aspects, the at least one QCL configuration comprises a QCL Type E, where the QCL Type E may include spatial transmission parameters.

At 1104, the network entity may provide the TCI state configuration regarding the target reference signal including the at least one QCL configuration comprising the spatial transmission parameters shared with the source signal. For example, 1104 may be performed by QCL component 199 of network entity 1302. The network entity may provide, to a UE, the TCI state configuration regarding the target reference signal including the at least one QCL configuration comprising the spatial transmission parameters shared with the source signal.

At 1106, the network entity may provide the target reference signal associated with the TCI state configuration. For example, 1106 may be performed by QCL component 199 of network entity 1302. The network entity may provide the target reference signal associated with the TCI state configuration to the UE. A transmission spatial filter of the target reference signal may correspond to the source signal from the TCI state configuration. In some aspects, the transmission spatial filter of the target reference signal may be identical or equivalent to the source signal of the at least one QCL configuration.

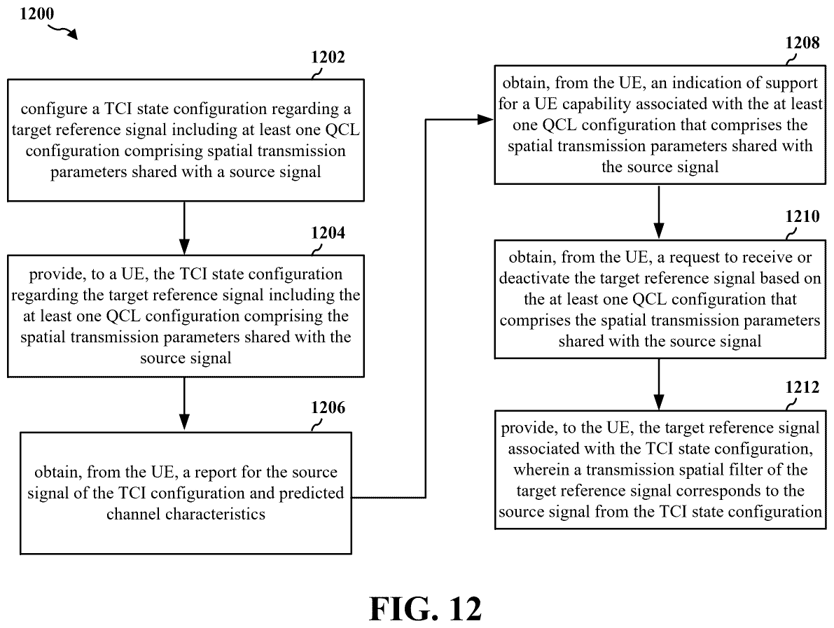

FIG. 12 is a flowchart 1200 of a method of wireless communication. The method may be performed by a base station (e.g., the base station 102; the network entity 1302. One or more of the illustrated operations may be omitted, transposed, or contemporaneous. The method may configure a UE to improve beam prediction accuracy based on spatial transmission parameters.

At 1202, the network entity may configure a TCI state configuration. For example, 1202 may be performed by QCL component 199 of network entity 1302. The TCI state configuration may be regarding a target reference signal including at least one QCL configuration comprising spatial transmission parameters shared with a source signal. In some aspects, the at least one QCL configuration may comprise a QCL Type D configuration. At least one of a MAC-CE, RRC signaling, or DCI associated with the QCL Type D configuration may indicate that the target reference signal corresponds to the spatial transmission parameters used for transmission of the source signal of the Type D configuration in the TCI state configuration. In some aspects, the at least one QCL configuration comprises a QCL Type E, where the QCL Type E may include spatial transmission parameters.

At 1204, the network entity may provide the TCI state configuration regarding the target reference signal including the at least one QCL configuration comprising the spatial transmission parameters shared with the source signal. For example, 1204 may be performed by QCL component 199 of network entity 1302. The network entity may provide, to a UE, the TCI state configuration regarding the target reference signal including the at least one QCL configuration comprising the spatial transmission parameters shared with the source signal.

At 1206, the network entity may obtain a report for the source signal of the TCI configuration and predicted channel characteristics. For example, 1206 may be performed by QCL component 199 of network entity 1302. The network entity may obtain the report for the source signal of the TCI configuration and predicted channel characteristics from the UE. For example, the predicted channel characteristics may include a predicted layer 1 (L1) reference signal received power (RSRP), L1 signal to interference plus noise ratio (SINR), rank indicator (RI), channel quality indicator (CQI), precoding matrix indicator (PMI), or being one of a predicted top resources.

At 1208, the network entity may obtain an indication of support for a UE capability associated with the at least one QCL configuration that may comprise the spatial transmission parameters shared with the source signal. For example, 1208 may be performed by QCL component 199 of network entity 1302. The network entity may obtain the indication of support for the UE capability from the UE. In some aspects, the UE capability may indicate at least one of support for the at least one QCL configuration comprising virtual resources, support for the at least one QCL configuration comprising a source based on SSB or CSI-RS, support for the at least one QCL configuration comprising the virtual resources or the source based on the SSB or the CSI-RS, or a lack of support for the at least one QCL configuration. In some aspects, the support for the UE capability may be indicated for at least one of a use case scenario or functionality with regards to the at least one QCL configuration. In some aspects, the UE capability may indicate a maximum number of MAC-CE activated TCI states with the at least one QCL configuration that comprises the spatial transmission parameters shared with the source signal.

At 1210, the network entity may obtain a request to receive or deactivate the target reference signal. For example, 1210 may be performed by QCL component 199 of network entity 1302. The network entity may obtain the request to receive or deactivate the target reference signal from the UE. The network entity may obtain the request to receive or deactivate the target reference signal based on the at least one QCL configuration that comprises the spatial transmission parameters shared with the source signal. In some aspects, the request may be comprised within a MAC-CE or UCI. In some aspects, the request may correspond to target channels of the target reference signal.

At 1212, the network entity may provide the target reference signal associated with the TCI state configuration. For example, 1212 may be performed by QCL component 199 of network entity 1302. The network entity may provide the target reference signal associated with the TCI state configuration to the UE. A transmission spatial filter of the target reference signal may correspond to the source signal from the TCI state configuration. In some aspects, the transmission spatial filter of the target reference signal may be identical or equivalent to the source signal of the at least one QCL configuration.

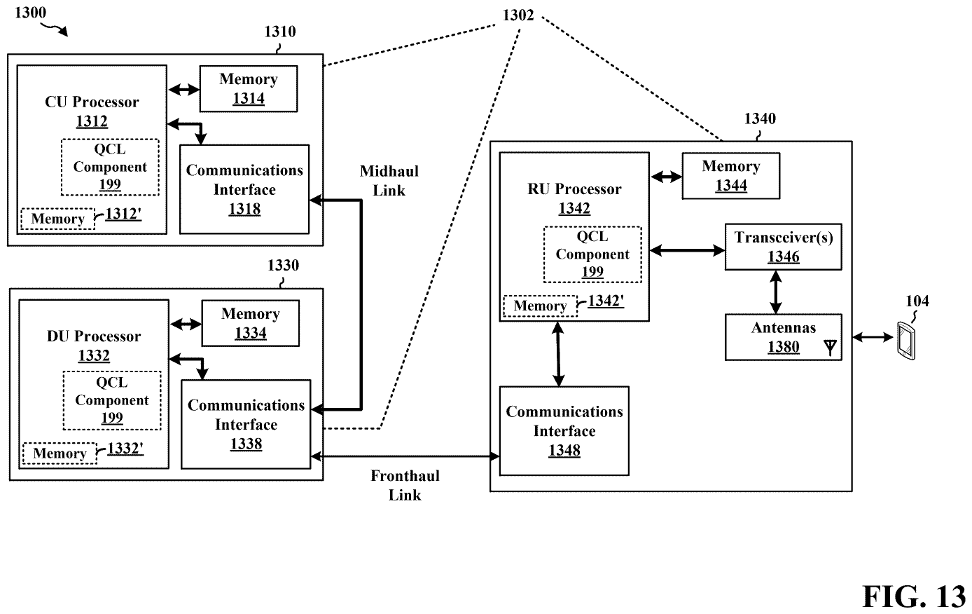

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to configure a TCI state configuration regarding a target reference signal including at least one QCL configuration comprising spatial transmission parameters shared with a source signal; provide, to a UE, the TCI state configuration regarding the target reference signal including the at least one QCL configuration comprising the spatial transmission parameters shared with the source signal; and providing, to the UE, the target reference signal associated with the TCI state configuration, wherein a transmission spatial filter of the target reference signal corresponds to the source signal from the TCI state configuration. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for configuring a TCI state configuration regarding a target reference signal including at least one QCL configuration comprising spatial transmission parameters shared with a source signal. The network entity includes means for providing, to a UE, the TCI state configuration regarding the target reference signal including the at least one QCL configuration comprising the spatial transmission parameters shared with the source signal. The network entity includes means for providing, to the UE, the target reference signal associated with the TCI state configuration, wherein a transmission spatial filter of the target reference signal corresponds to the source signal from the TCI state configuration. The network entity further includes means for obtaining, from the UE, a report for the source signal of the TCI configuration and predicted channel characteristics. The network entity further includes means for obtaining, from the UE, an indication of support for a UE capability associated with the at least one QCL configuration that comprises the spatial transmission parameters shared with the source signal. The network entity further includes means for obtaining, from the UE, a request to receive or deactivate the target reference signal based on the at least one QCL configuration that comprises the spatial transmission parameters shared with the source signal. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented. The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising receiving a TCI state configuration regarding a target reference signal including at least one QCL configuration comprising spatial transmission parameters shared with a source signal; and receiving, from a network entity, the target reference signal associated with the TCI state configuration, wherein a transmission spatial filter of the target reference signal corresponds to the source signal from the TCI state configuration.

Aspect 2 is the method of aspect 1, further including transmitting, to the network entity, a report for the source signal of the TCI state configuration and predicted channel characteristics.

Aspect 3 is the method of any of aspects 1 and 2, further including transmitting, to the network entity, an indication of support for a UE capability associated with the at least one QCL configuration that comprises the spatial transmission parameters shared with the source signal.

Aspect 4 is the method of any of aspects 1-3, further includes that the UE capability indicates at least one of support for the at least one QCL configuration comprising virtual resources, support for the at least one QCL configuration comprising a source based on SSB or CSI-RS, support for the at least one QCL configuration comprising the virtual resources or the source based on the SSB or the CSI-RS, or a lack of support for the at least one QCL configuration.

Aspect 5 is the method of any of aspects 1-4, further includes that the support for the UE capability is indicated for at least one of a use case scenario or functionality with regards to the at least one QCL configuration.

Aspect 6 is the method of any of aspects 1-5, further includes that the UE capability indicates a maximum number of MAC-CE activated TCI states with the at least one QCL configuration that comprises the spatial transmission parameters shared with the source signal.

Aspect 7 is the method of any of aspects 1-6, further including transmitting, to the network entity, a request to receive or deactivate the target reference signal based on the at least one QCL configuration that comprises the spatial transmission parameters shared with the source signal.

Aspect 8 is the method of any of aspects 1-7, further includes that the request is transmitted via MAC-CE or UCI.

Aspect 9 is the method of any of aspects 1-8, further includes that the request corresponds to target channels of the target reference signal.

Aspect 10 is the method of any of aspects 1-9, further includes that the at least one QCL configuration comprises a QCL Type E.

Aspect 11 is the method of any of aspects 1-10, further includes that the at least one QCL configuration comprises a QCL Type D configuration, wherein at least one of a MAC-CE, RRC signaling, or DCI associated with the QCL Type D configuration indicates that the target reference signal corresponds to the spatial transmission parameters used for transmission of the source signal of the QCL Type D configuration in the TCI state configuration.

Aspect 12 is the method of any of aspects 1-11, further includes that the transmission spatial filter of the target reference signal is identical to the source signal of the at least one QCL configuration.

Aspect 13 is the method of any of aspects 1-12, further including measuring the target reference signal; and predicting a beam measurement based on the transmission spatial filter of the target reference signal corresponding to the source signal of the at least one QCL configuration, wherein an accuracy of a beam prediction is refined based at least on the at least one QCL configuration from the TCI state configuration regarding the target reference signal.

Aspect 14 is the method of any of aspects 1-13, further including monitoring performance of a beam prediction based at least on the at least one QCL configuration from the TCI state configuration regarding the target reference signal.

Aspect 15 is an apparatus for wireless communication at a UE including at least one processor coupled to a memory and at least one transceiver, the at least one processor configured to cause the UE to implement any of Aspects 1-14.

Aspect 16 is an apparatus for wireless communication at a UE including means for implementing any of Aspects 1-14.

Aspect 17 is a computer-readable medium storing computer executable code, where the code when executed by a processor causes the processor to implement any of Aspects 1-14.

Aspect 18 is a method of wireless communication at a network entity comprising configuring a TCI state configuration regarding a target reference signal including at least one QCL configuration comprising spatial transmission parameters shared with a source signal; providing, to a UE, the TCI state configuration regarding the target reference signal including the at least one QCL configuration comprising the spatial transmission parameters shared with the source signal; and providing, to the UE, the target reference signal associated with the TCI state configuration, wherein a transmission spatial filter of the target reference signal corresponds to the source signal from the TCI state configuration.

Aspect 19 is the method of aspect 18, further including obtaining, from the UE, a report for the source signal of the TCI state configuration and predicted channel characteristics.

Aspect 20 is the method of any of aspects 18 and 19, further including obtaining, from the UE, an indication of support for a UE capability associated with the at least one QCL configuration that comprises the spatial transmission parameters shared with the source signal.

Aspect 21 is the method of any of aspects 18-20, further includes that the UE capability indicates at least one of support for the at least one QCL configuration comprising virtual resources, support for the at least one QCL configuration comprising a source based on SSB or CSI-RS, support for the at least one QCL configuration comprising the virtual resources or the source based on the SSB or the CSI-RS, or a lack of support for the at least one QCL configuration.

Aspect 22 is the method of any of aspects 18-21, further includes that the support for the UE capability is indicated for at least one of a use case scenario or functionality with regards to the at least one QCL configuration.

Aspect 23 is the method of any of aspects 18-22, further includes that the UE capability indicates a maximum number of MAC-CE activated TCI states with the at least one QCL configuration that comprises the spatial transmission parameters shared with the source signal.

Aspect 24 is the method of any of aspects 18-23, further including obtaining, from the UE, a request to receive or deactivate the target reference signal based on the at least one QCL configuration that comprises the spatial transmission parameters shared with the source signal.

Aspect 25 is the method of any of aspects 18-24, further includes that the request is comprised within a MAC-CE or UCI.

Aspect 26 is the method of any of aspects 18-25, further includes that the request corresponds to target channels of the target reference signal.

Aspect 27 is the method of any of aspects 18-26, further includes that the at least one QCL configuration comprises QCL Type E.

Aspect 28 is the method of any of aspects 18-27, further includes that the at least one QCL configuration comprises a QCL Type D configuration, wherein at least one of a MAC-CE, RRC signaling, or DCI associated with the QCL Type D configuration indicates that the target reference signal corresponds to the spatial transmission parameters used for transmission of the source signal of the QCL Type D configuration in the TCI state configuration.

Aspect 29 is the method of any of aspects 18-28, further includes that the transmission spatial filter of the target reference signal is identical to the source signal of the at least one QCL configuration.

Aspect 30 is an apparatus for wireless communication at a network entity including at least one processor coupled to a memory and at least one transceiver, the at least one processor configured to cause the network entity to implement any of Aspects 18-28.

Aspect 31 is an apparatus for wireless communication at a network entity including means for implementing any of Aspects 18-28.

Aspect 32 is a computer-readable medium storing computer executable code, where the code when executed by a processor causes the processor to implement any of Aspects 18-28.

1. An apparatus for wireless communication at a user equipment (UE), comprising:
a memory; and
at least one processor coupled to the memory and, based at least in part on information stored in the memory, the at least one processor is configured to cause the UE to:
receive a transmission configuration indicator (TCI) state configuration regarding a target reference signal including at least one quasi co-located (QCL) configuration comprising spatial transmission parameters shared with a source signal; and
receive, from a network entity, the target reference signal associated with the TCI state configuration, wherein a transmission spatial filter of the target reference signal corresponds to the source signal from the TCI state configuration.

2. The apparatus of claim 1, further comprising a transceiver coupled to the at least one processor.

3. The apparatus of claim 1, wherein the at least one processor is configured to cause the UE to:
transmit, to the network entity, a report for the source signal of the TCI state configuration and predicted channel characteristics.

4. The apparatus of claim 1, wherein the at least one processor is configured to cause the UE to:
transmit, to the network entity, an indication of support for a UE capability associated with the at least one QCL configuration that comprises the spatial transmission parameters shared with the source signal.

5. The apparatus of claim 4, wherein the UE capability indicates at least one of:
support for the at least one QCL configuration comprising virtual resources,
support for the at least one QCL configuration comprising a source based on synchronization signal block (SSB) or channel state information reference signal (CSI-RS),
support for the at least one QCL configuration comprising the virtual resources or the source based on the SSB or the CSI-RS, or
a lack of support for the at least one QCL configuration.

6. The apparatus of claim 4, wherein the support for the UE capability is indicated for at least one of a use case scenario or functionality with regards to the at least one QCL configuration.

7. The apparatus of claim 4, wherein the UE capability indicates a maximum number of MAC-CE activated TCI states with the at least one QCL configuration that comprises the spatial transmission parameters shared with the source signal.

8. The apparatus of claim 1, wherein the at least one processor is configured to cause the UE to:
transmit, to the network entity, a request to receive or deactivate the target reference signal based on the at least one QCL configuration that comprises the spatial transmission parameters shared with the source signal.

9. The apparatus of claim 8, wherein the request is transmitted via media access control (MAC) control element (CE) (MAC-CE) or uplink control information (UCI).

10. The apparatus of claim 8, wherein the request corresponds to target channels of the target reference signal.

11. The apparatus of claim 1, wherein the at least one QCL configuration comprises a QCL Type E.

12. The apparatus of claim 1, wherein the at least one QCL configuration comprises a QCL Type D configuration, wherein at least one of a media access control (MAC) control element (CE) (MAC-CE), radio resource control (RRC) signaling, or downlink control information (DCI) associated with the QCL Type D configuration indicates that the target reference signal corresponds to the spatial transmission parameters used for transmission of the source signal of the QCL Type D configuration in the TCI state configuration.

13. The apparatus of claim 1, wherein the transmission spatial filter of the target reference signal is identical to the source signal of the at least one QCL configuration.

14. The apparatus of claim 1, wherein the at least one processor is configured to cause the UE to:
measure the target reference signal; and
predict a beam measurement based on the transmission spatial filter of the target reference signal corresponding to the source signal of the at least one QCL configuration, wherein an accuracy of a beam prediction is refined based at least on the at least one QCL configuration from the TCI state configuration regarding the target reference signal.

15. The apparatus of claim 1, wherein the at least one processor is configured to cause the UE to:
monitor performance of a beam prediction based at least on the at least one QCL configuration from the TCI state configuration regarding the target reference signal.

16. A method of wireless communication at a user equipment (UE), comprising:
receiving a transmission configuration indicator (TCI) state configuration regarding a target reference signal including at least one quasi co-located (QCL) configuration comprising spatial transmission parameters shared with a source signal; and
receiving, from a network entity, the target reference signal associated with the TCI state configuration, wherein a transmission spatial filter of the target reference signal corresponds to the source signal from the TCI state configuration.

17. An apparatus for wireless communication at a network entity, comprising:
a memory; and
at least one processor coupled to the memory and, based at least in part on information stored in the memory, the at least one processor is configured to cause the network entity to:
configure a transmission configuration indicator (TCI) state configuration regarding a target reference signal including at least one quasi co-located (QCL) configuration comprising spatial transmission parameters shared with a source signal;
provide, to a user equipment (UE), the TCI state configuration regarding the target reference signal including the at least one QCL configuration comprising the spatial transmission parameters shared with the source signal; and
provide, to the UE, the target reference signal associated with the TCI state configuration, wherein a transmission spatial filter of the target reference signal corresponds to the source signal from the TCI state configuration.

18. The apparatus of claim 17, further comprising a transceiver coupled to the at least one processor.

19. The apparatus of claim 17, wherein the at least one processor is configured to cause the network entity to:
obtain, from the UE, a report for the source signal of the TCI state configuration and predicted channel characteristics.

20. The apparatus of claim 17, wherein the at least one processor is configured to cause the network entity to:
obtain, from the UE, an indication of support for a UE capability associated with the at least one QCL configuration that comprises the spatial transmission parameters shared with the source signal.

21-30. (canceled)
